(19) United States
(12) Patent Application Publication
(10) Pub. No.: US 2015/0149339 A1
(43) Pub. Date: May 28, 2015

(54) Methods for Enhancing Debt Collection Efficiency

(71) Applicant: Billy Richard Bartmann, Tulsa, OK (US)

(72) Inventor: Billy Richard Bartmann, Tulsa, OK (US)

(21) Appl. No.: 14/599,333

(22) Filed: Jan. 16, 2015

Related U.S. Application Data
(63) Continuation-in-part of application No. 14/075,449, filed on Nov. 8, 2013.
(60) Provisional application No. 61/724,694, filed on Nov. 9, 2012.

(51) Int. Cl. G06Q 40/00

(52) U.S. Cl. CPC G06Q 40/00
USPC 705/35

(57) ABSTRACT

The methods of this invention solve the problem of low recovery of debt by allowing debtors to communicate with debt collectors through a secure electronic portal, thus allowing debtors to work with debt collectors on their own schedules and reducing embarrassment and tension that may arise during telephone conversations.

### RELATED APPLICATIONS

This application claims the benefit of U.S. Patent Application 61/724,694, filed on Nov. 9, 2012, and U.S. patent application Ser. No. 14/075,449, filed Nov. 8, 2013.

### BACKGROUND OF THE INVENTION

The business of extending credit and debt collections has existed for hundreds of years and for the most part has remained unchanged throughout its history. The typical debtor has every intention of repaying the debt when purchasing on credit or borrowing funds. However, for various reasons, sometimes within the debtor's control and sometimes beyond the debtor's control, the debtor cannot repay the debt. At some point, the lender resigns itself to taking a loss on the debt and turns to a collection agency to assist with the collection of some portion of the debt.

The term “debt collector” is used interchangeably to describe any business that pursues payment of debts owed by individuals or business or that provides debt negotiation, debt settlement, credit counseling or debt management services to consumers at no cost or at low cost. A “collection agency” acts as an agent of the creditor which originally extended the credit (or the original creditor's successor in interest) or of the consumer who owes the debt and usually, but not always, is compensated by a fee representing a percentage of the amount owed or collected. A debt buyer is a business that purchases the debt from the creditor for cents on the dollar, and then keeps whatever it collects from the debtor. By way of example, if a debtor owes $10,000, the creditor may sell the debt to a debt buyer for $1,000, and the debt buyer manages to get the debtor to pay back $2,000, leaving a $1,000 profit for the debt buyer. Current statistics indicate that for consumer credit card debt, once the debt reaches a debt collector, the rate of recovery is only a fraction of the face value of the debt. For debt purchased by a debt buyer, the rate of recovery is about 2½ to 3 times the amount paid for the debt.

Despite state and federal laws and regulations which govern the activities of debt collectors and prevent egregious conduct, current debt collection strategies have changed little over the years. They follow the basic pattern: Contact the debtor, try to negotiate a lump sum payment or payment plan, and failing that, bring a lawsuit that will likely end with a judgment against the debtor that may or may not be collectable.

A knowledgeable and disciplined debtor may be able to negotiate successfully with a debt collector, but given that a lack of knowledge and discipline may have led to the debtor's financial condition, this is not always a successful strategy. Alternatively, debt settlement and debt counseling services companies promise relief from debt collectors; by way of example, an Internet search for “consumer debt management” generates millions of hits from debt counseling services. However, as the Federal Trade Commission warns, “There is no guarantee that the services debt settlement companies offer are legitimate. There also is no guarantee that a creditor will accept partial payment of a legitimate debt. In fact, if you stop making payments on a credit card, late fees and interest usually are added to the debt each month. If you exceed your credit limit, additional fees and charges also can be added. This can cause your original debt to double or triple. All these fees will put you further in the hole.” In fact, debt settlement companies have a poor reputation for providing value for the fees they charge.

What is lacking with current debt collection and debt negotiation strategies is the inherent conflict with the debt collector's goals and an understanding, on the part of the debt collector, of the mindset of the majority of debtors. Further, debt collectors largely have no knowledge of the circumstances that led to the debtor's default or the specific challenges the debtor is facing currently. Most debtors, if given the opportunity, would prefer to repay at least a substantial portion of their debts. However, they lack two things—an inclination to cooperate with the debt collector and an ability to come up with the funds necessary to repay the debt. Current debt collection strategies do nothing to address these deficiencies, and oftentimes work to increase the deficiencies. For example, a debt collector may, subject to laws and regulations, call a debtor repeatedly, demean the character of the debtor, and so on, diminishing the debtor's desire to cooperate. Further, the debt collector may make unreasonable demands for repayment terms that are based on internal policies rather than the debtor's ability to pay, leaving the debtor unable to repay the debt, and increasing the likelihood that the debt collector will take a total or near total loss on the debt.

Further, traditional communications between debtors and debt collectors is inefficient, time consuming, and tension-filled. For example, when communicating through traditional mail, letters take days to be delivered to the debtors, and sometimes are sent with return-receipt-requested, meaning that debtors must be home to sign for the delivery. When communicating through phone calls, debtors must be available (and prepared) when the debt collectors call; moreover, even when the debt collectors are fully professional and polite in speaking on the phone with debtors, there is an inherent tension and embarrassment when debtors must explain their financial problems to the debt collectors.

What is needed, therefore, is a method for facilitating the repayment of debt that increases the debtor's willingness to cooperate with the debt collector and increases the debtor's ability to repay a greater portion of the debt.

### SUMMARY OF THE INVENTION

The methods of this invention solve the problem of low recovery of debt by, prior to recovery of the debt, increasing the debtor's willingness and ability to repay the debt, and only after increasing the debtor's willingness and ability to repay the debt, facilitating the recovery of an appropriate amount of the debt into the hands of the owner of the debt.

By way of example, a debt collector operating according to the inventive methods may establish direct contact with the debtor—meeting in person, via telephone, or by exchanging letters, as well as emails, faxes, texts, and other direct electronic communications—in order to facilitate communication, gathering of necessary information, completion of documents and agreements and obtaining the necessary consents from the debtor for the debt collector to act on behalf of the debtor to obtain the desired services. Alternatively, the debt collector may make available to the debtor, or any other consumer desirous of obtaining the services, an automated computerized platform where the debtor may directly enter the necessary information, authorize the review of credit reports and other information, receive information and assistance for job searches or social services, and allow the debt collector's computerized proprietary algorithmic analytic engine to utilize the relevant information received from the debtor and other sources in order to develop a unique profile and associated evaluative results (including, for example, an ability to pay score, a willingness to pay score and a combinative unique individual score that reflects the weighted meaningful characteristics describing the debtor's personal and family situation) in order that electronic communication may be established between the debtor and debtor's creditors as a mechanism to facilitate offers and counter-offers of debt settlement. The direct and automated computerized platform methods of delivery of services are not mutually exclusive and may be used in any combination that is suitable for the debtor or the consumer.

By way of further example, a debt collector operating according to the inventive methods may have the debtor authorize the debt collector to represent the debtor's interest in negotiations with the debtor's other creditors. Not only does this end the barrage of debt collector phone calls placed to the debtor, the debtor obtains the benefit of the debt collector's intellectual knowledge or automated computerized expertise in negotiating an advantageous debt settlement. As this has an almost immediate impact, debtor's inclination to pay increases significantly. It also increased the debtor's ability to pay by reducing the amount the debtor owes to his or her other creditors.

By way of further example, a debt collector operating according to the inventive methods helps the debtor find employment or get better employment. The debt collector can do this by creating a more persuasive resume, identifying potential job openings, and coaching the debtor on job interview skills or by providing an automated computerized platform that satisfies those same needs. This acts both to increase the debtor's inclination to pay as well as potentially increasing the debtor's ability to pay.

By way of further example, a debt collector operating according to the inventive methods may utilize an automated computerized platform that helps the debtor apply for governmental programs or private social programs for which the debtor may be eligible. If the debtor can obtain a temporary stream of income from a governmental program or address a housing or nutritional deficiency, the debtor will have more resources to pay the debt, and therefore has an increased ability to pay. Once the forgoing actions have been substantially or fully completed, the debtor has an increased inclination and ability to pay. The debt collector can then prepare a repayment plan commensurate with the debtor's enhanced ability to pay.

By way of further example, a debt collector operating under the inventive methods helps the debtor identify legal counsel in cases where the debtor has been sued by a creditor or where a creditor has violated federal or state laws regarding debt collection. The delivery of services under the inventive methods works to build a trust relationship between the debt collector and the debtor. The debt collector who provides services that improve the debtor's quality of life will recognize a significant positive impact on the debtor's willingness to pay as the debtor comes to appreciate and develop a sense of trust for the debt collector.

While in the prior art, others—such as for-profit and non-profit businesses as well as government agencies—have provided similar portions of the inventive methods, none offer all elements of the inventive methods. For example, a private or government social program may help the debtor find employment, a separate legal aid organization may help the debtor in collection lawsuits brought by creditors, and a separate charity may offer discounted medical care. Some unscrupulous debt settlement companies demand several months of advance payments from the debtor before ever commencing debt negotiations; if the debtor pays some, but not all of the advance payments, the debt settlement company keeps the advance payment without providing any services whatsoever.

In contrast, a debt collector, following the methods disclosed in this application, offers the debtor with the full menu of services associated with the inventive methods free of charge or at a charge less than the debt collector's cost of providing the service, with the debt collector absorbing the expenses as a cost of doing business. The inventor has found that through application of the inventive methods, a relationship based on trust is created and a debt collector operating according to the inventive methods receives fewer consumer complaints—a happy debtor is less likely to Name the collection agency or original creditor for financial difficulties. This can enhance the public reputation of both the debt collector and the original creditor. Further, once the debtor has successfully repaid the debt, the former debtor, having enjoyed the benefit of a trusting relationship, is more likely to turn to the debt collector for advice and guidance on a wide range of financial and non-financial products. Often, the debtor may turn to the original creditor for future financing needs and the creditor is more likely to be willing to extend credit to the former debtor, knowing that the former debtor is now better equipped to manage debt.

### BRIEF DESCRIPTION OF THE DRAWINGS

FIG. 1 is a flow chart showing the initial intake of a new case when processed through direct contact.

FIG. 2 is a flow chart showing the overview of an alternative debt collection pathway applicable to certain debtors.

FIG. 3 is a flow chart showing the overview of the inventive service.

FIGS. 4a and 4b are together a flow chart showing the details of the debt negotiation and settlement services portion of the inventive service.

FIG. 5 is a flow chart showing the details of the provision of social services portion of the inventive service.

FIGS. 6a and 6b are together a flow chart showing the details of the provision of career services portion of the inventive service.

FIG. 7 is a flow chart showing the details of the litigation referral services portion of the inventive service.

FIG. 8 is an example of a communication from a debt collector using the inventive service to a debtor following initial intake.

FIG. 9 is an example of the Letter of Representation Consent Form signed by a debtor under the inventive service.

FIG. 10 is an example of a letter sent to a debtor's creditors by a debt collector under the inventive service.

FIG. 11 is a flow chart showing the initial intake of a new case when processed through an automated computerized platform.

FIGS. 12a and 12b are together a flow chart showing the initial intake of a new case when processed through an automated computerized platform.

### DETAILED DESCRIPTION OF THE INVENTION

While the invention is susceptible of embodiments in many different forms, there is shown in the drawings and will herein be described in detail several possible embodiments of the invention with the understanding that the present disclosure is to be considered as an exemplification of the principles of the invention and is not intended to limit the broad aspects of the invention to the embodiments illustrated as relates to the various types of debts that the debt collector would resolve under the inventive method or the relationship between the debt collector and the owner of the particular type of debt.

Initial Contact

The purpose of the initial contact between the debtor and debt collector is to inform the debtor of the identity of the debt collector and the creditor it represents (if any), to make certain legally-required disclosures to the debtor, and to begin the process of negotiating reparation. However, a debt collector operating according to the inventive methods will use this initial contact with the debtor to establish a non-adversarial relationship between the debtor and debt collector. Initial contact can come in the form of any of a variety of traditional communications mechanisms, including but not limited to telephonic, mail or internet, or entirely through the automated computerized platform.

In other embodiments, debtors may be contacted by mail, via the debt collector's website or by other electronic means, or may be referred directly to the automated computerized platform by a debt collector or any other person. In each case, the objective is to incentivize the debtor either to establish telephonic communication so that the intake interview and associated explanation of services available may be had or to enroll for services through the automated computerized platform. It is possible to communicate and establish a relationship with the debtor solely by mail and/or electronic means, or solely through use of the automated computerized platform.

Secure Portals for Debtors and Creditors

All debtor interaction with the automated computerized platform will take place via a secure debtor portal which may only be accessed by a debtor using an individually-assigned username and password. The debtor will use the debtor portal for the debt negotiation functions of entry, review or revision of the debtor's information, sending and receiving electronic messages to or from the system provider or a creditor, accepting or declining settlement offers from creditors or creating counteroffers to creditors. The debtor may upload informational documents such as tax returns, pay stubs, W-2 forms, balance sheets, rent receipts, bank statements and similar documents that could be relevant to an effective presentation to and review by a creditor. Additionally, the debtor portal will be used by the debtor in order to utilize the various tools related to employment searches, government and private social programs, and other money management and financial education tools and programs. The debtor portal can be implemented using any technology that provides an electronic user interface, including by way of example and not limitation a web server or mobile app server.

Creditors will interact with automated computerized platform through a secure creditor portal which may only be accessed by a creditor using an individually-assigned username and password. The creditor will use the creditor portal for the debt negotiation functions of sending and receiving electronic messages to or from the system provider or a debtor, accepting or declining settlement offers from debtors or creating counteroffers to debtors. Additionally, the creditor portal will be used by the creditor to review a debtor's informational profile and relevant information and documents that were uploaded into the automated computerized platform by the debtor. The creditor portal can be implemented using any technology that provides an electronic user interface, including by way of example and not limitation a web server or mobile app server.

Letter of Representation

Debt collectors hired by creditors may strictly follow state and federal regulations, they may be exploiting grey areas in those regulations, or they may be ignoring those regulations altogether. At best, the debtor is merely overwhelmed by the volume of legitimate phone calls and letters, and at worst, the debtor is receiving harassing and intimidating phone calls and letters.

Under federal law, a debtor has the right to inform a debt collector that he or she is represented by an attorney, and once the debt collector is on notice of this representation, the debt collector may no longer contact the debtor directly, but instead must contact the attorney. A debtor also has the right to inform the debt collector that he or she is represented by a non-attorney third party representative, and once the debt collector is on notice of this representation, the debt collector will by custom, rather than law, observe the debtor's wishes and contact only the third party representative. A debt collector operating according to the inventive methods may have the debtor execute a Letter of Representation or Power of Attorney that is a form of consent and designation of authorized representative authorizing the debt collector to represent the debtor's interest in negotiations with the debtor's other creditors. If the Letter of Representation or Power of Attorney is obtained physically, the debt collector sends the Letter of Representation or Power of Attorney and designation of authorized representative to the other creditors informing them that they can no longer contact the debtor concerning the outstanding obligation, but instead must contact the debt collector agency. If the Letter of Representation or Power of Attorney is obtain through the automated computerized platform the Letter of Representation or Power of Attorney, in electronic form and bearing the debtor's electronic signature, will be relayed to the creditor electronically.

The immediate benefit to the debtor is the cessation of the harassing phone calls from a number of debt collectors that may or may not be following state and federal regulations.

In other embodiments, the debt collector may advise the Client to seek bankruptcy counsel or the services of an accredited credit counseling agency or a debtor rights attorney to pursue claims against a creditor for violations of state or federal law.

Debt Settlement Negotiation

The debt collector contacts each of the respective creditors of the debtor and begins to negotiate on behalf of the debtor. Because the debt collector is skilled and a more experienced negotiator, typically it can better communicate the debtor's financial situation and thus effectuate a larger discount or a structured payment plan that the debtor could have obtained if acting alone. If the debtor is utilizing the automated computerized platform, an analysis of the information input by the debtor and information gathered from internal and external databases is performed using the computerized proprietary algorithmic analytic engine in order to develop a unique profile and associated evaluative results (including, for example, an ability to pay score, a willingness to pay score and a combinative unique individual score that reflects the weighted meaningful characteristics describing the debtor's personal and family situation) in order that electronic communication may be established between the debtor and debtor's creditors as a mechanism to facilitate offers and counter-offers of debt settlement. The resulting restructuring of the debtor's obligations results in improving the debtor's cash flow and financial position, thus improving both the debtor's willingness and ability to repay his or her creditors, including the debt collector in the event the debtor has such an obligation.

Debtor Employment

Even with an increased inclination to pay, a debtor cannot begin reparation of a debt without money, and in many cases, the debtor is unemployed or under-employed. There are many causes of un- and under-employment, including seasonal shifts, downturns in the economy, injury/illness, lack of qualifications, and so on. A debt collector cannot repair a sluggish economy or a bad back, however, for a majority of debtors, a debt collector operating according to the inventive methods can take a number of actions that will enhance the employability of the debtor.

In the course of establishing a relationship with the debtor, the debt collector will obtain background and employment history from the debtor through either direct contact or the automated computerized platform. If the contact is direct, the debt collector then prepares a professional resume for the debtor. The debt collector sends this resume back to the debtor for his or her own use, and also sends the resume off to Internet job posting sites, such as Monster.com, LinkedIn, CareerBuilder, HotJobs, and CraigsList. Alternatively, if the contact is through the automated computerized platform, the debtor has the option to input the debtor's job history and other personal information into data templates and to create, store and print different versions of professional resumes.

Further, if in direct contact, the debt collector may perform Internet searches for employment that match the skill set and education level of the debtor. Once such an opening is identified, the debt collector obtains permission from the debtor to prepare a job application on behalf of the debtor. When the job application is completed, the debt collector sends it along with the previously prepared resume to the prospective employer. The debt collector may then follow-up with the prospective employer to arrange an interview for the debtor. Once the interview time is set, the debt collector counsels the debtor on interview skills and dress.

Additionally, the automated computerized platform may provide the capability to facilitate job searches in the geographic area that are of interest to the debtor, completion of job applications and routing the debtor's job application or resume electronically to targeted employers.

Further, the debt collector may, directly or through the automated computerized platform, provide additional counseling to the debtor to enhance the debtor's employability. By way of example and not limitation, this could include advising the debtor on interview skills, conducting mock interviews, and advising the debtor on proper interview attire.

In other embodiments, the debt collector may, directly or through the automated computerized platform, counsel the debtor on opportunities to improve job skills or obtain a job in other locations across the country where the debtor's existing skills may be in higher demand.

Government and Private Social Program Benefits

Many debtors whose financial circumstances have put them in a place where they are now being pursued by debt collectors are also eligible for a number of governmental programs on the federal, state and local level, such as Social Security, Medicare/Medicaid, Food Stamps, transportation, and child care. However, many debtors are not familiar with the eligibility requirements for these programs, and others find themselves overcome by the often-confusing application processes. A debtor who can take advantage of these governmental programs may spend less of his or her paycheck on food, medicine, housing, and the like, resulting in more of the paycheck being available to repay the debt.

In the course of establishing a relationship with the debtor, the debt collector operating according to the inventive methods will obtain detailed information about the debtor's assets, liabilities, income, and expenses. With this information, the debt collector will be able to determine the debtor's eligibility for various government and private social programs and will be able to assist the debtor in completion and submission of the appropriate applications.

By way of example and not limitation, the governmental social programs include Social Security disability, Social Security Supplemental Income, Medicaid, Supplemental Nutrition Assistance Program, unemployment benefits, education and job training, and housing assistance. In the course of establishing a trust relationship with the debtor, the debt collector operating according to the inventive methods may provide life coaching and success skills, including money management and financial literacy skills. Often, debtors who have lost employment or are behind on their bills will experience a low self-esteem. The debt collector can provide resources in the form of teleseminars, CDs/DVDs, on-line videos, self-paced learning programs, workbooks and other literature to help the debtor to see themselves other than as victims. Recovering from a setback begins with the debtor seeing themselves as a worthwhile individual and successful.

By way of example and not limitation, private social programs include temporary housing shelters, food banks, discount prescription coupons, utility assistance, Salvation Army and other United Way or charitable agencies and non-profit credit counseling. Sometimes, a debtor's situation has deteriorated to the point that food and housing is a challenge, although more commonly, the debtor may need assistance with prescription medicines and dental care. The debt collector can provide the debtor with guidance in locating the most applicable private social programs based on the debtor's particular circumstances.

Litigation Referral

In the course of establishing a relationship with the debtor, the debt collector operating according to the inventive methods will obtain detailed information about the debtor's other debts, including those creditors who may litigate with the consumer and those creditors who may have violated state or federal collection laws.

By way of example and not limitation, referral of the debtor to knowledgeable legal resources who may provide representation to the debtor is of high value to the debtor and enhances the debtor's willingness and ability to repay the debt.

### An Embodiment of the Inventive Methods

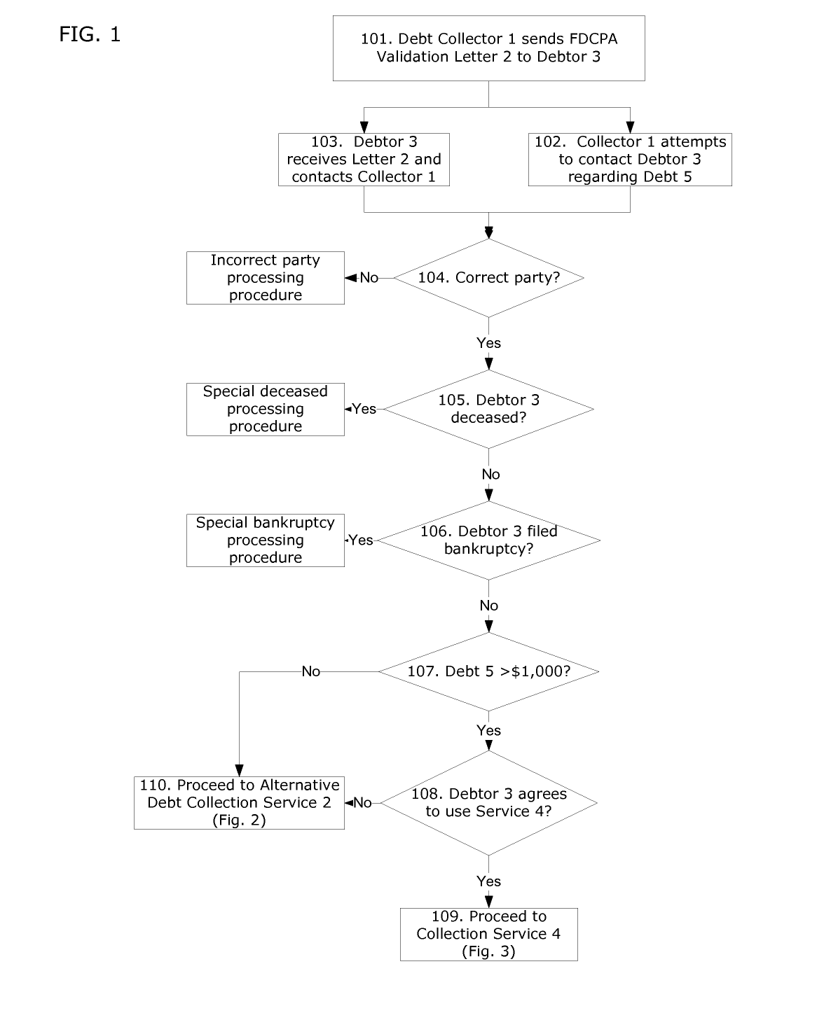

FIG. 1 shows Debt Collector 1's direct contact intake of new Debt 5 owed by Debtor 3. Debt Collector 1 will have some information about Debtor 3 and Debt 5; by way of example and not limitation, if a creditor has sold Debt 5 to Debt Collector 1, the creditor may provide the name, address, phone number, and specific information about Debt 5. In steps 101 and 102, Debt Collector 1 sends the mandatory FDCPA Validation Letter, if required by law, to Debtor 3 and attempts to make contact with Debtor 3 by phone. As shown in step 103, Debtor 3 may self-respond to Debt Collector 1. As shown in steps 104-108, during this initial call, Debt Collector 1 makes some initial inquiries to confirm the applicability of inventive Collection Service 4; Debt Collector 1 may also explain the debt collection process, including an overview of Collection Service 4, to Debtor 3. If Collection Service 4 is inapplicable to Debtor 3 (for example, if Debtor 3 has filed bankruptcy or is deceased), then Debt Collector 1 utilizes special processing procedures unique for that situation. Otherwise, Debt Collector 1 proceeds to collect the debt using traditional debt collection techniques which are outside of the scope of this invention.

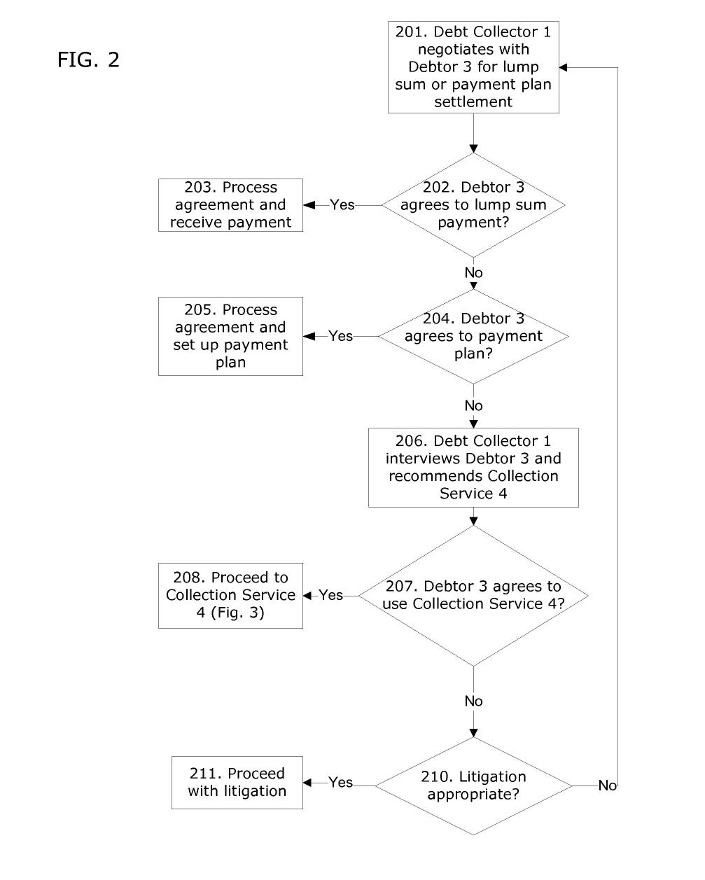

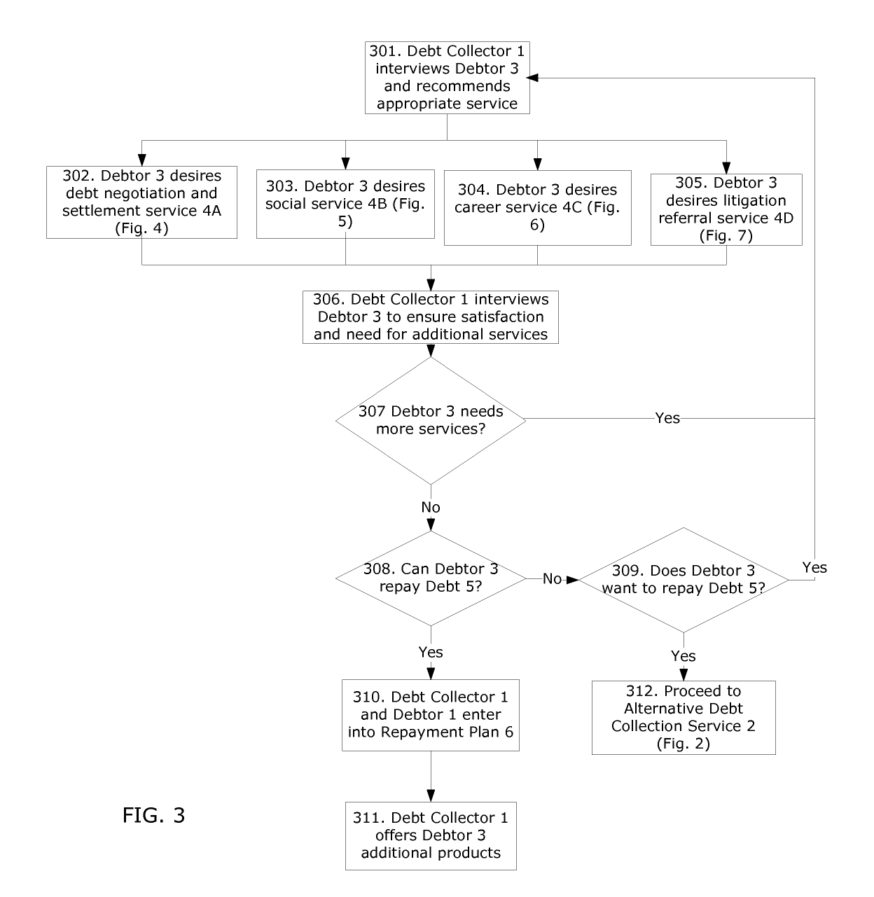

As shown in step 107, if Debtor 3 owes a debt to Debt Collector 1 and the amount of the debt is less than a minimal amount (in this case, $1,000), it may be more appropriate for both Debtor 3 and Debt Collector 1 to initially pursue collection through a more traditional Alternative Debt Collection Service 2. As shown in FIG. 2, Alternative Debt Collection Service 2 begins with more traditional collection steps—negotiating either a lump sum settlement (step 202) or a payment plan (step 204). However, if Debtor 3 remains unable to repay, then Debtor 3 and Debt Collector 1 may agree to proceed with inventive Collection Service 4. If Debtor 3 does not agree to use Collection Service 4, then Debtor 3 will remain in Alternative Debt Collection Service 2 until Debt 5 is resolved, either through settlement, write-off, or litigation.

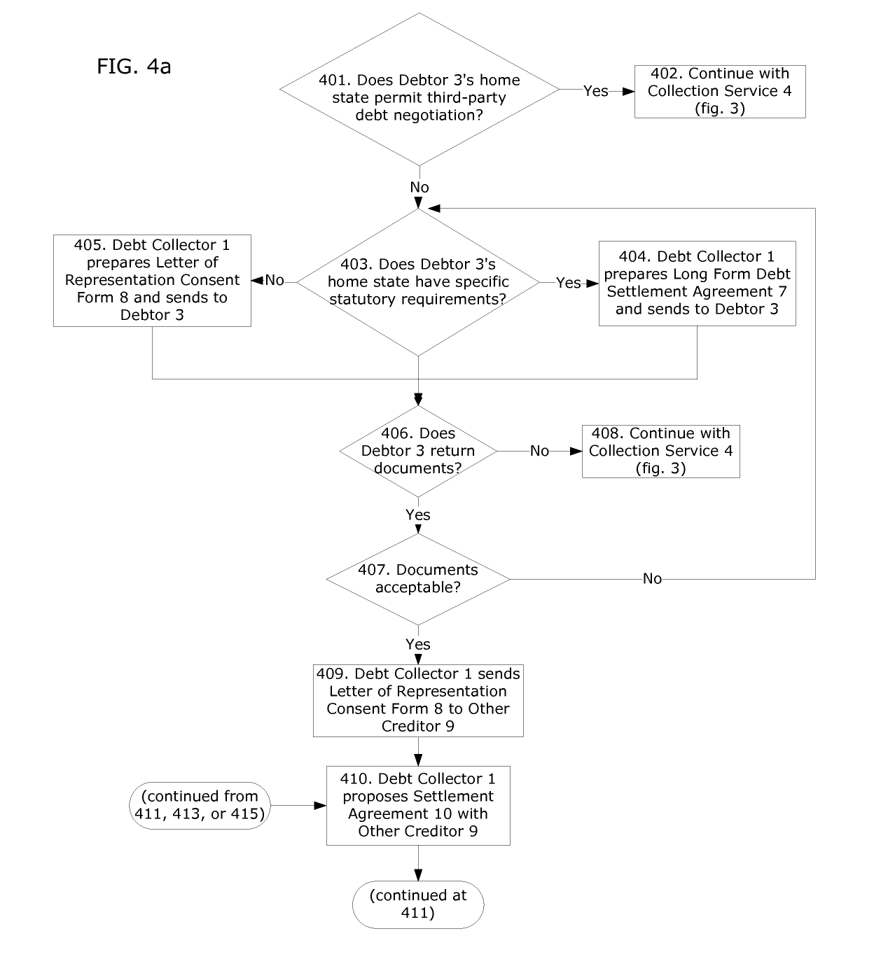

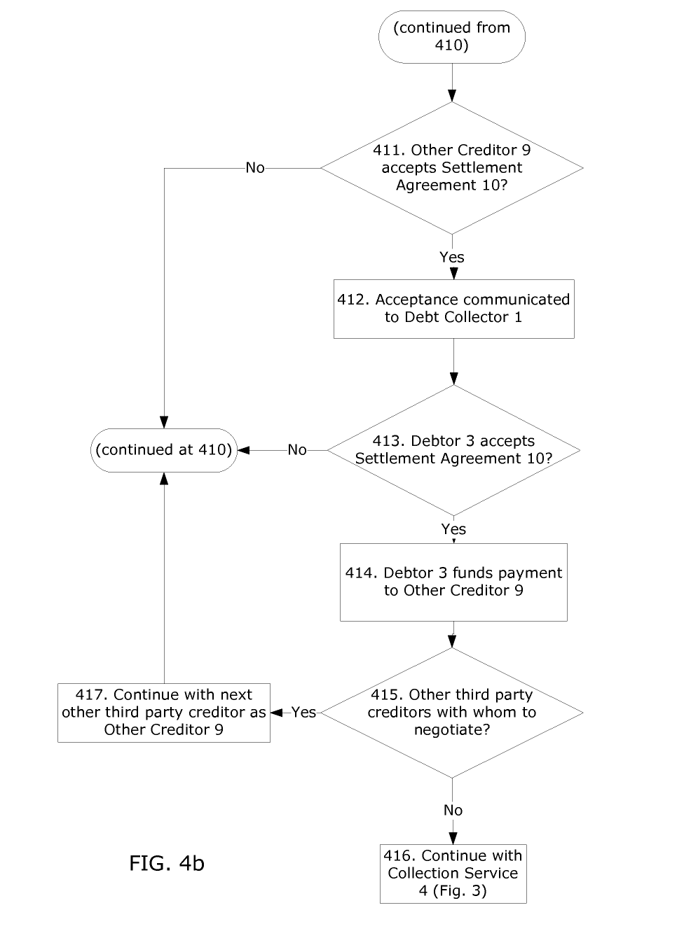

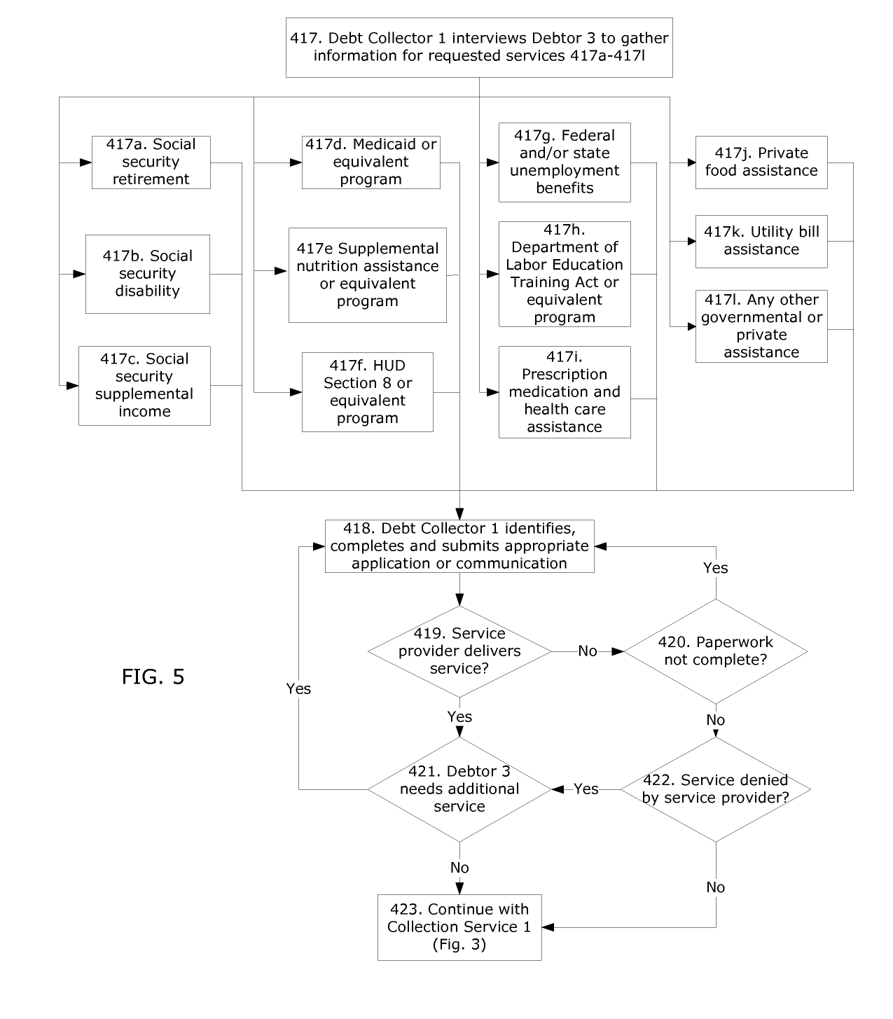

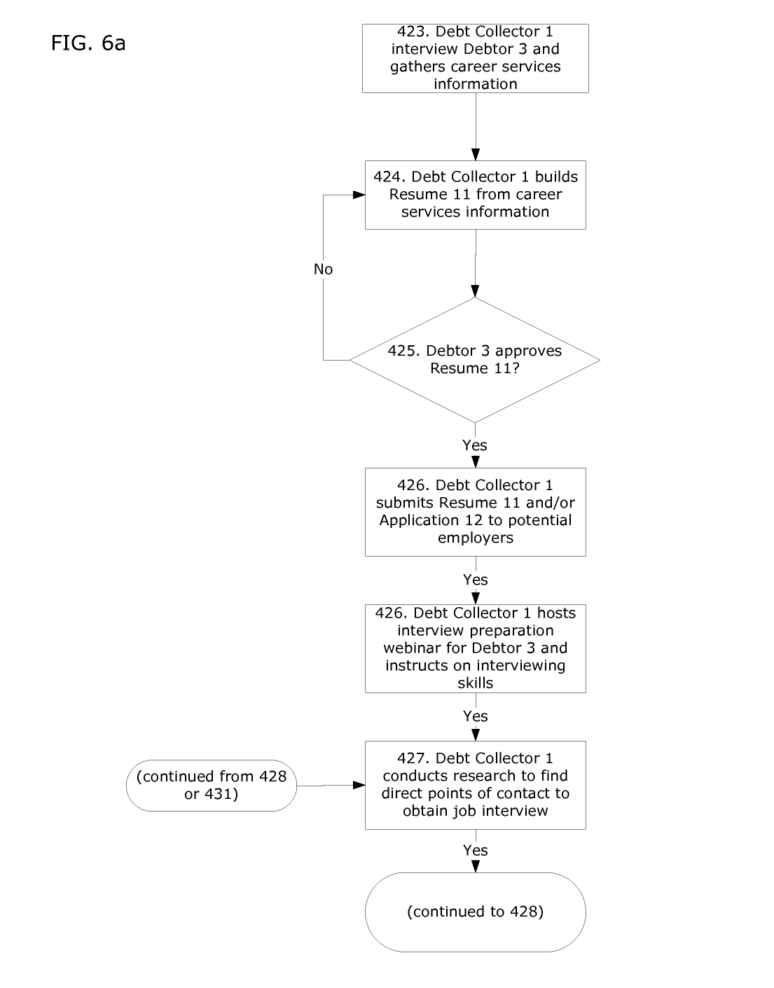

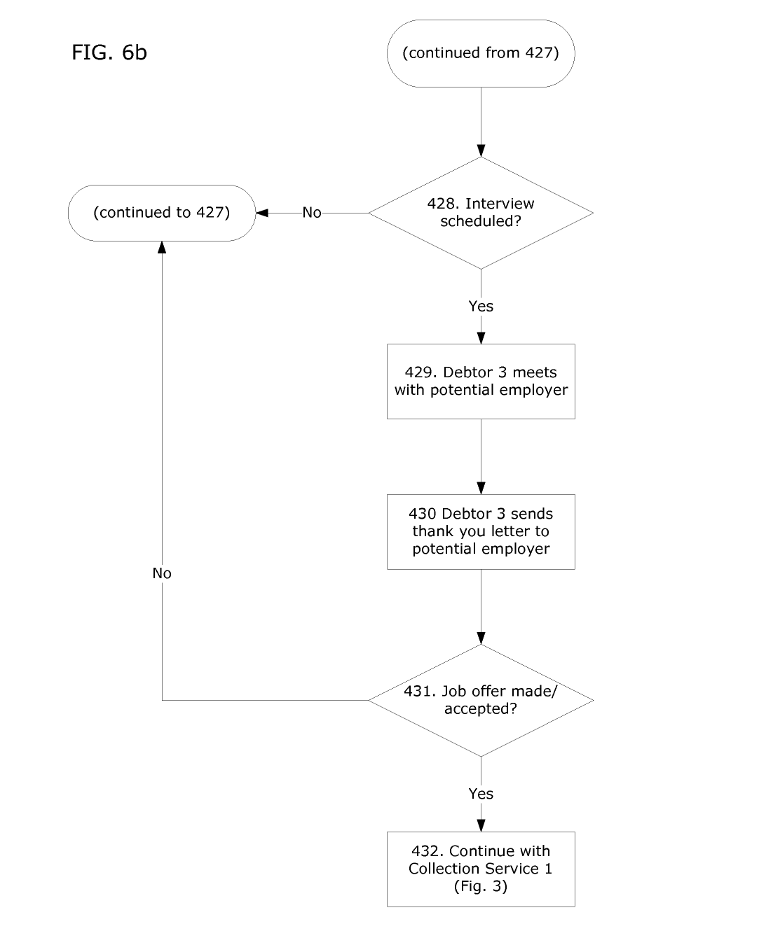

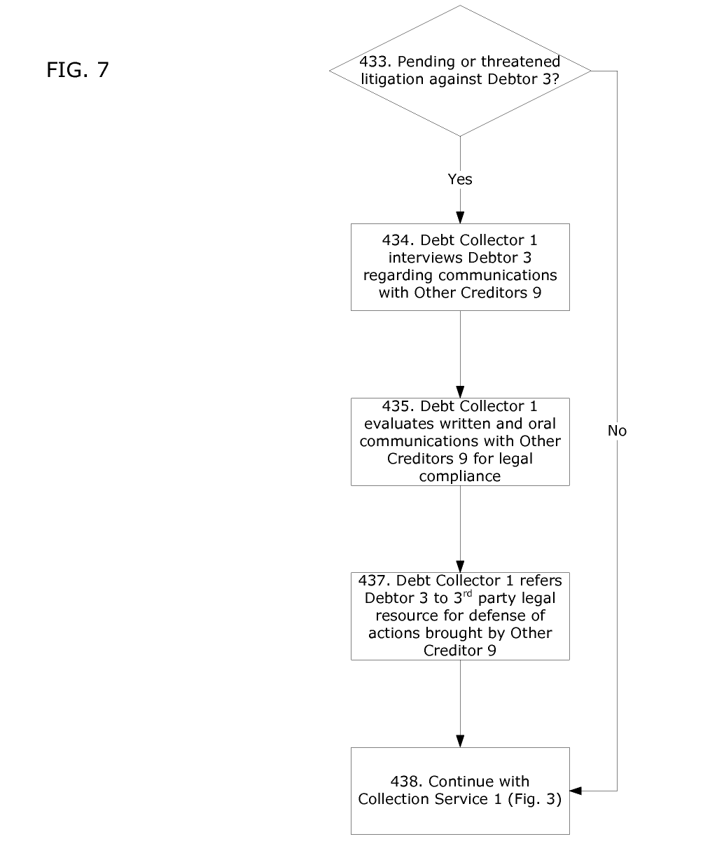

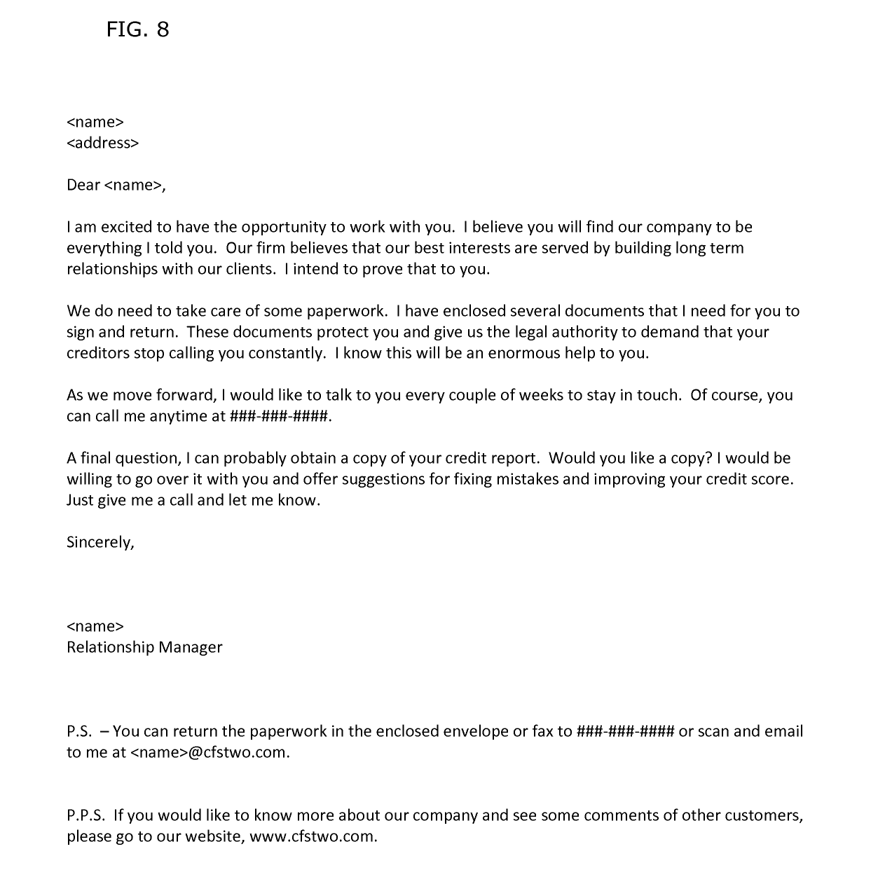

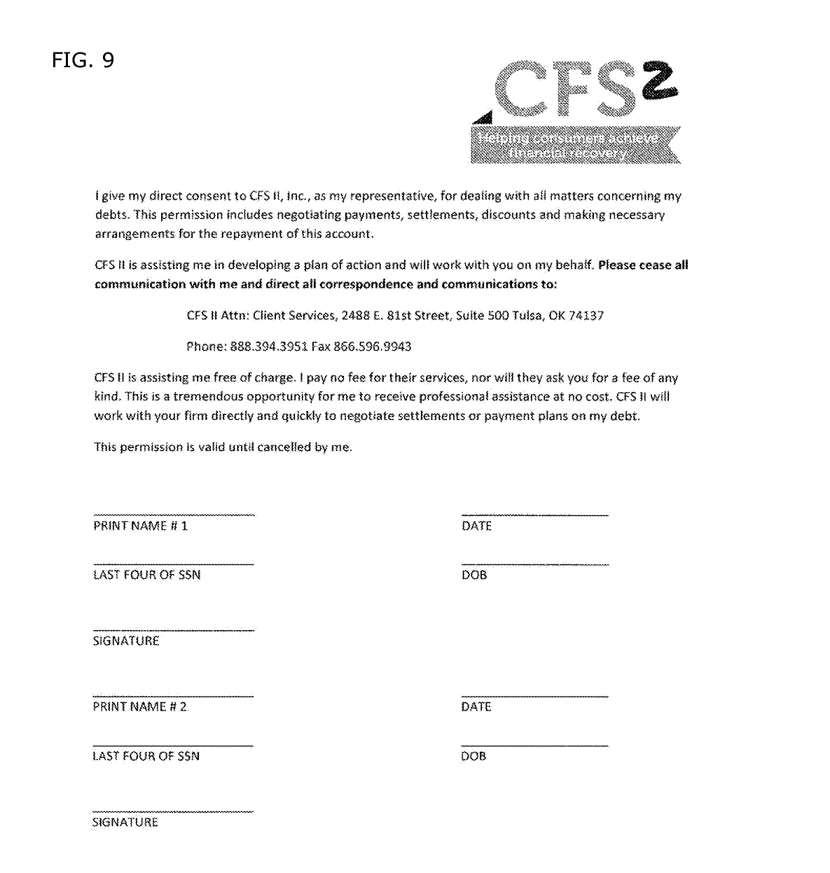

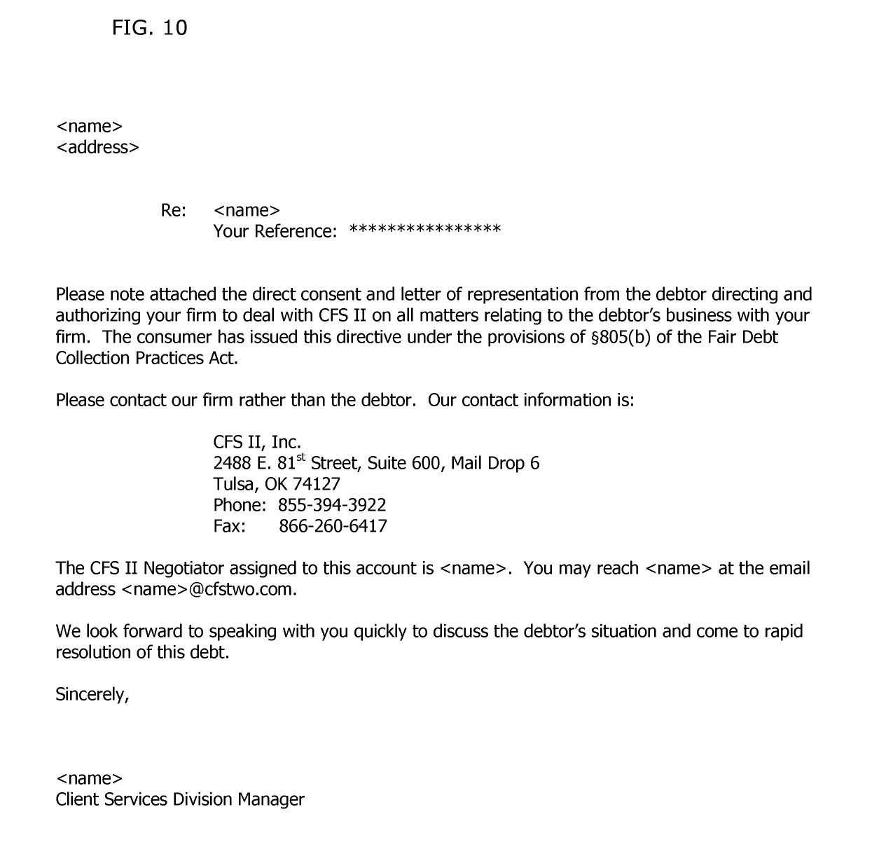

FIGS. 3-7 show of the inventive Collection Service 4 when operation in a mode of direct contact between Debt Collector 1 and Debtor 3 (that is, when Debtor 3 is not using Debt Collector 1's Debtor Portal). Collection Service 4 begins in step 301 with an interview of Debtor 3. The purpose of this interview is to determine which of the specific components of Collection Service 4 are applicable to Debtor 3. During step 301, Debt Collector 1 may fill out worksheets and interview forms, and at the end of the initial interview, Debt Collector 1 will recommend specific elements of the inventive Collection Service 4. The various elements of Collection Service 4 may require Debt Collector 1 to send to Debtor 3 various consent forms, disclosures, questionnaires, lists of other creditors and status of other debt, asset/liability worksheets, income expense worksheets, and where necessary under state law, a contract agreement or a letter of representation; some states may have additional documentation requirements and some states simply do not allow debt negotiation by a licensed collection agency. Debtor 3 completes and returns various authorization documents, consents, and information forms as are required for the specific collection service(s) utilized. FIG. 8 shows an example cover letter sent to Debtor 3 regarding Collection Service 4. FIG. 9 shows a sample consent form executed by Debtor 3 that authorizes Debt Collector 1 to deal directly with other creditors of Debtor 3 in the delivery of Collection Service 4. FIG. 10 shown a sample letter to Debtor 3's other creditors in the delivery of Collection Service 4. In steps 204-207, Debt Collector 1 provides Debt Negotiation and Settlement Services 4A, Social Services 4B, Career Services 4C, and/or Litigation Referral Services 4D. Note that depending on Debtor 3's particular situation, Debt Collector 1 may not provide all of these services. Further note that there is no particular sequential order in the provision of these services, and in fact provision of services may overlap.

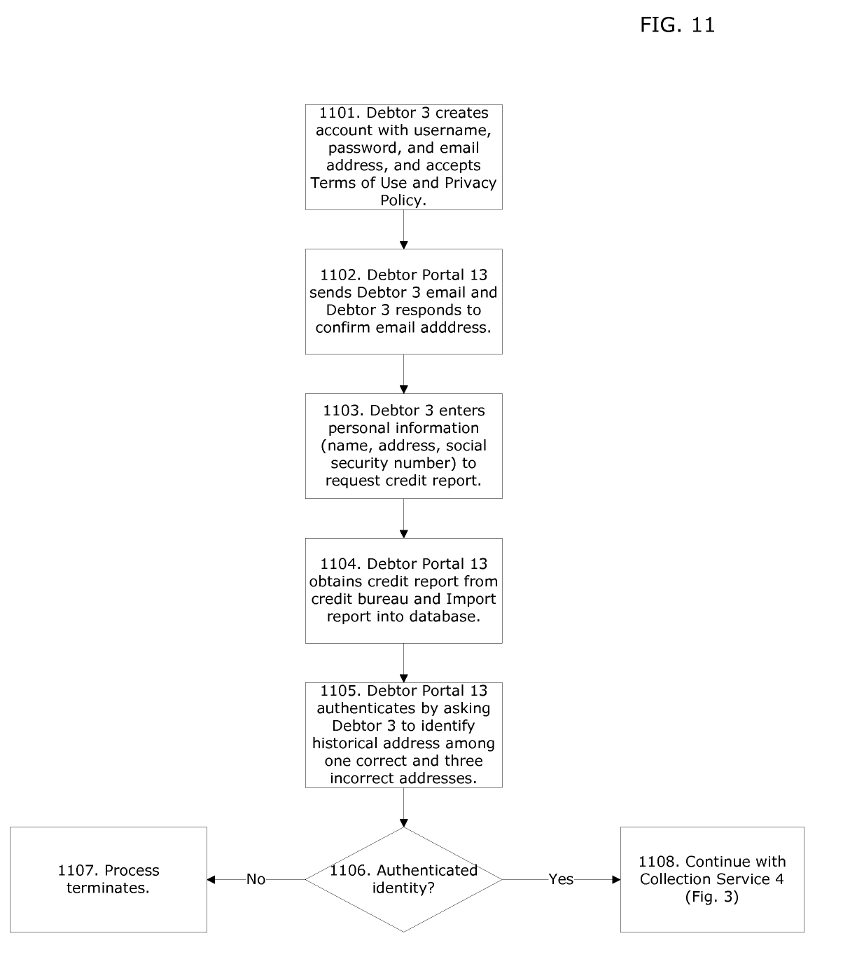

FIG. 11 shows initiation of Collection Service 4 when in operational mode of the automated computerized platform between Debt Collector 1 and Debtor 3. First, in step 1101, Debtor 3 uses Debtor Portal 13 to create a user account. Debtor Portal 13 interacts with Debtor 3 to authenticate the identity of Debtor 3. Authentication steps 1102-1105 may include validation of an email address and cross checking basic personal information obtained from a credit bureau's consumer credit report. If Debtor 3 is authenticated, Collection Service 4 continues generally as described in FIG. 3, except that interactions between Debtor 3 and Debt Collector 1 are performed electronically. For example, when Debt Collector 1 “interviews” Debtor 3 (for example, step 301), the interview may be performed by presenting Debtor 3 with a series of menus, fill-in-the-blank forms, drop-down selections, checkboxes, radio buttons, and/or other user-interface mechanisms commonly known in the art. Further, when Debtor 3 is required to return signed documents (for example, step 406), where permitted by law Debtor 3 may electronically “sign” the document using an electronic sound, symbol, or process, attached to or logically associated with a contract or other record and executed or adopted by a person with the intent to sign the record; where required or otherwise deemed desirable, it may include an authenticated digital signature and it may include the use of a third-party electronic signature service such as DocuSign. Further, when documents are transferred between Debtor 3 and Debt Collector 1 (for example, step 405), the transfer mechanism may be any electronic data communication commonly known in the art, such as email or a file hosting service such as DropBox or Google Drive. Further, as a practical matter, electronic transfer of personally identifiable information will require the use of encrypted links, passwords, PINs, and other data security measures commonly known in the art.

FIG. 3 shows the details of Debt Negotiation and Settlement Services 4A. This service begins with Debt Collector 1 determining the eligibility of Debtor 3 under state law governing the provision of debt negotiation and settlement services by Debt Collector 1. Once eligibility of Debtor 3 is determined, Debt Collector may send a Long Form Debt Settlement Agreement 7 and/or Letter of Representation Consent Form 8 to Debtor 3. (Some states require a written services agreement which includes a letter of representation. See, e.g., TEX. FIN. CODE ANN. §394.209; CAL. CIV. CODE §1789.16.) FIG. 9 shows an example of Letter of Representation Consent Form 8. After Debtor 3 has returned Contract Agreement 7 and Consent Form 8, Debt Collector 1 contacts each Other Creditor 9 to inform Other Creditor 9 that Debt Collector 1 is authorized to negotiate on behalf of Debtor 3. FIG. 10 shows an example of a letter to Other Creditor 9. Debt Collector 1 negotiates with each Other Creditor 9 until they come up with a Settlement Agreement 10 that is acceptable to Debtor 3.

FIG. 5 shows the details of Social Services 4B. Because Debt Collector 1 has obtained detailed information about Debtor 3's finances, age, and health, and is in a position to determine the likelihood that Debtor 3 may be eligible for various governmental or private social services. As shown in steps 417-422, these services include (but are not limited to) Social Security Retirement Benefits, Medicare, Social Security Disability Insurance, Social Security Supplemental Income, Medicaid, Supplemental Nutrition Assistance Program (or a state/local equivalent), HUD Section 8 housing (or a state/local equivalent), state or federal unemployment benefits, or Department of Labor Education Training Act programs (or a state/local equivalent) assistance with prescription medicines and health care, private food assistance, and assistance with utility bills. Depending on requirements of a particular program, Debt Collector 1's services may include counseling Debtor 3 on the program requirements, sending forms to Debtor 3, and/or preparing program applications, in whole or in part, on behalf of Debtor 3.

FIG. 6a and FIG. 6b shows the details of Career Services 4C. This service begins with Debt Collector 1 collecting information about Debtor 3's work history, education, training, availability, and any physical work limitations. Based either on an existing resume provided by Debtor 3, or starting from scratch, Debt Collector 1 prepares Resume 11. After confirming the accuracy of Resume 11 with Debtor 3, Debt Collector 1 researches the job marked based on Debtor 3's geographic location and qualifications. Based on this research, Debt Collector 1 may post Resume 11 on various job search web sites and/or on specific employer job web sites. Debt Collector 1 works with Debtor 3 to identify any job interview opportunities that may be available. Debt Collector 1 may assist Debtor 3 with preparation and submission of one or more Application 12. If opportunities are available, Debt Collector 1 (or Debtor 3) schedule interview(s), and Debt Collector 1 coaches Debtor 3 on job interview skills and conducts mock interviews to ensure the Debtor 3 is prepared for the job interview.

FIG. 7 shows the details of Litigation Referral Service 4D. If any Other Creditor 9 is threatening litigation or has already initiated litigation against Debtor 3 for other debt, Debt Collector 1 counsels Debtor 3 on Debtor 3's rights and Other Creditor 9 obligations on collection activities. Debt Collector 1 may also counsel Debtor 3 on requirements for documenting improper collection activities which may violate state or federal collection laws. If litigation is threatened or pending, Debt Collector 1 may refer Debtor 3 to qualified third-party counsel for defense of Debtor 3. Further, if there have been improper collection activities, Debt Collector 1 may refer Debtor 3 to qualified third-party counsel for bringing an action against Other Creditor 9.

After the provision of the applicable services, Debtor 3 should be in a position to repay some or all of Debt 5, and Debtor 3 will enter into a Repayment Nan 6 with Debt Collector 1. Debtor 3 may be in an improved financial situation such that Debtor 3 may be interested in purchasing various financial-related products from Debt Collector 1. If Debtor 5 does not successfully complete Debt Negotiation and Settlement Services 4A, Social Services 4B, Career Services 4C, and/or Litigation Referral Services 4D, or if Debtor 5 is otherwise unable to repay Debt 5, Debt Collector 1 will attempt to collect the debt using traditional debt collection techniques which are outside of the scope of this invention.

### Other Embodiments

The preferred embodiment shown in FIGS. 1-10 is but one of a number of embodiments based on the inventive methods of this patent. Other embodiments of this inventive methods of this patent may vary on specific details, however, so long as the embodiment does not depart from the spirit of the invention, which facilitates the repayment of debt by, prior to recovery or payment of the debt, increasing the debtor's willingness and ability to repay the debt, and only after increasing the debtor's willingness and ability to repay the debt and establishing a relationship based on trust, collecting or facilitating the recovery of the optimum amount of the debt.

Further, the embodiments of the inventive methods have been described from the perspective of “Debt Collector 1,” a term which as used here refers generally to any business—for example, an original creditor, a successor to the original creditor, a third-party debt collector, a debt buyer, or a government agency—that pursues payment of debts owed by individuals or businesses or that provides debt negotiation, debt settlement, credit counseling or debt management services to consumers. However, subject to regulatory restrictions, these same inventive methods can be customized to apply to any entity attempting to recover or facilitate the payment of a debt owed, whether that debt originated from a financed purchase, an unsecured loan, a monetary fine, a one-time or recurring payment, or virtually any other legal obligation to pay.

Further, the embodiments of the inventive methods have been described from the perspective of “Debtor 3”, a term which as used herein refers to any natural person with a monetary obligation to another natural person or a business, and specifically regardless of any monetary obligation between “Debtor 3” and “Debt Collector 1”.

Further, the embodiments of the inventive methods have been described as facilitated by “Debt Collector 1” to “Debtor 3” through direct or electronic communication or through an automated computerized platform utilizing multiple data gathering processes and one or more algorithmic processes to derive scores that reflect the debtor's willingness to repay a debt, the debtor's ability to repay a debt, and a unique combination of scores that measures the dynamics of the debtor's environment, or through any combination thereof.

Further, the foregoing embodiments of the inventive methods have been primarily described from the perspective of the interactions between Debt Collector 1 and Debtor 3. However, as earlier, a secure creditor portal interface between Debt Collector 1 and a creditor could be used together with a secure debtor portal.

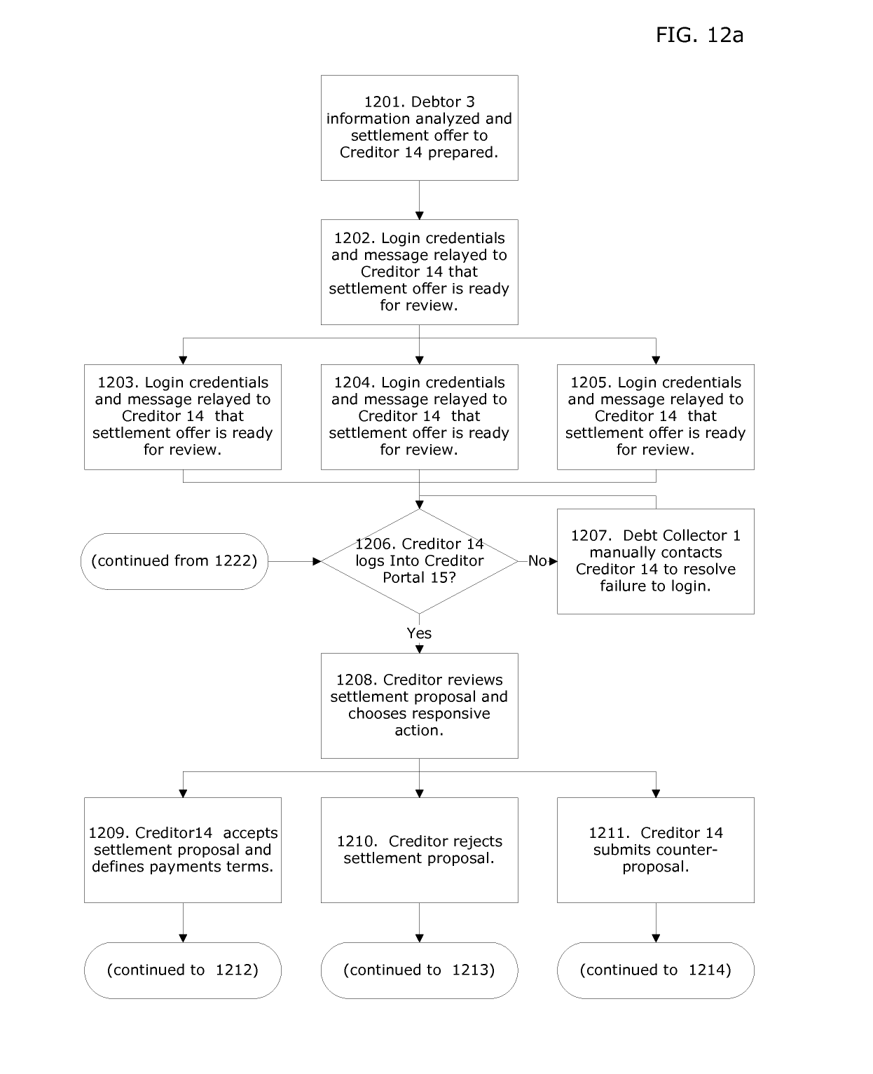

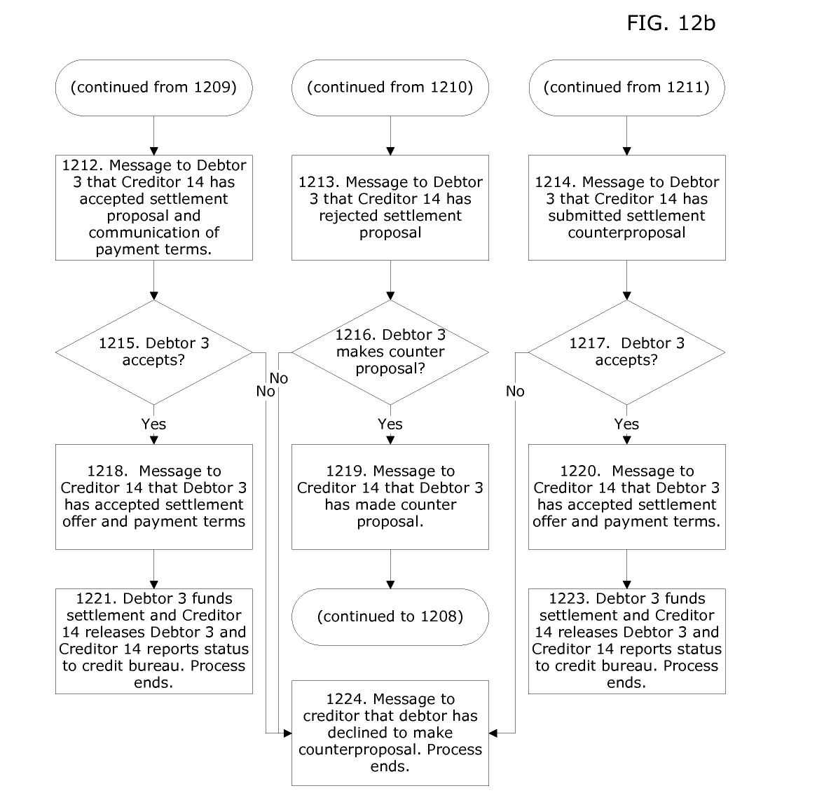

FIGS. 12a and 12b outline the process flow of interactions between Debt Collector 1 and a Creditor 14 using Creditor Portal 15. Following Debt Collector 1's analysis of the Debtor 3 information and preparation of a settlement offer in Step 1201, Debt Collector 1 will send a message to Creditor 14 using Creditor Portal 15 with notice of a pending settlement offer and login credentials so that Creditor 14 may gain access to Creditor Portal in Step 1202. The message to Creditor 14 may take multiple paths as described in Steps 1203-1205 depending on the best available method of establishing communication with Creditor 14.

In steps 1206 and 1208 Creditor 14 will login to Creditor Portal 15, review the settlement proposal and choose an action. In Step 1207, Debt Collector 1 will establish direct communication with Creditor 14 in the event that Creditor 14 fails to login to Creditor Portal 15.

Steps 1209 to 1211 describe the various actions that Creditor 14 may take to accept the settlement offer, reject the settlement offer or make a counterproposal to the settlement offer.

If Creditor 14 accepts the settlement proposal in Step 1209, a message will be sent in Step 1212 advising Debtor 3 that Creditor 14 has accepted the proposal and has communicated payment terms. In Step 1215 Debtor 3 chooses to accept or reject the proposal. If Debtor 3 accepts the proposal, Step 1218 is a confirmation message from Debtor 3 to Creditor 14 that Debtor 3 has accepted the proposal and payment terms. In Step 1221 Debtor 3 will fund the settlement and Creditor 14 will release Debtor 3 and report the appropriate status to the credit bureau.

If Creditor 14 rejects the settlement proposal in Step 1210, a message will be sent in Step 1213 advising Debtor 3 that Creditor 14 has rejected the settlement proposal. In Step 1216 Debtor 3 may choose to make a counterproposal and in which case a message will be sent through Creditor Portal 15 to Creditor 14 in Step 1219.

If Creditor 14 submits a counterproposal to the settlement offer in Step 1211, a message will be sent through Creditor Portal 15 in step 1214 advising Debtor 3 that Creditor 14 has made a counterproposal. In Step 1217 Debtor 3 will choose to accept or reject Creditor 14's counterproposal. In the event Debtor 3 accepts the counterproposal a message will be sent through Creditor Portal 15 in Step 1220 to Creditor 14 reporting that Debtor 3 has accepted. In step 1223 Debtor 3 will fund the settlement and Creditor 14 will release Debtor 3 and report the appropriate status to the credit bureau. If Debtor 3 rejects the counterproposal, Step 1224 is the appropriate communication to Creditor 14.

1. A method of debt collection, comprising the steps:
using an electronic debtor portal to receive an electronic request for creation of an account for a debtor;
authenticating the identity of the debtor;
using the electronic debtor portal to conduct an interview of the debtor regarding a debt owed by the debtor to a creditor;
presenting the debtor, through the electronic debtor portal, with a letter of representation from the debtor, the letter of representation authorizing the debt collector to act on behalf of the debtor in relation to the debt;
obtaining, through the electronic debtor portal, the debtor's signature on the letter of representation; and
negotiating, on behalf the debtor, with a representative of the creditor regarding repayment of the debt.

2. The method of claim 1, where:
the electronic debtor portal is provided by an original creditor.

3. The method of claim 1, where:
the electronic debtor portal is provided by a third-party debt collector.

4. The method of claim 1, where:
the electronic debtor portal is provided by a debt buyer.

5. The method of claim 1, where:
the electronic debtor portal is provided by a governmental entity.

6. The method of claim 1, where:
the step of negotiating with a representative of the creditor is performed through communications through an electronic creditor portal.

7. A method of debt collection, comprising the steps:
using an electronic debtor portal to receive an electronic request for creation of an account for a debtor;
authenticating the identity of the debtor;
using the electronic debtor portal to conduct an interview of the debtor regarding a first debt owed by the debtor to an original creditor;
presenting the debtor, through the electronic debtor portal, with a letter of representation from the debtor, the letter of representation authorizing the debt collector to act on behalf of the debtor in relation to a second debt owed by the debtor to a second creditor;
obtaining, through the electronic debtor portal, the debtor's signature on the letter of representation;
negotiating, on behalf the debtor, with a representative of the second creditor regarding repayment of the second debt; and
negotiating, through the electronic debtor portal, with the debtor for repayment of the first debt.

8. The method of claim 7, where:
the electronic debtor portal is provided by the original creditor.

9. The method of claim 7, where:
the electronic debtor portal is provided by a third-party debt collector.

10. The method of claim 7, where:
the electronic debtor portal is provided by a debt buyer.

11. The method of claim 7, where:
the electronic debtor portal is provided by a governmental entity.

12. The method of claim 7, where:
the step of negotiating with a representative of the second creditor is performed through communications through an electronic creditor portal.
